(19) United States
(12) Patent Application Publication
(10) Pub. No.: US 2004/0168005 A1
(43) Pub. Date: Aug. 26, 2004

(54) Methods for interrupting a program and for obtaining program execution acquisition

(75) Inventor: Jan Civlin, Sunnyvale, CA (US)

Correspondence Address: MARTINE & PENILLA, LLP, 710 LAKEWAY DRIVE, SUITE 170, SUNNYVALE, CA, 94085, US

(73) Assignee: SUN MICROSYSTEMS, INC., Santa Clara, CA

(21) Appl. No.: 10/371,383

(22) Filed: Feb. 21, 2003

(51) Int. Cl. G06F 13/24; G06F 13/32

(52) U.S. Cl. 710/260; 710/267

(57) ABSTRACT

In a method for interrupting a program, a threshold of a hardware performance counter is adjusted and a program is interrupted when the hardware performance counter reaches the threshold. The method can be used to monitor performance of program code and to interrupt the execution of the program code on the basis of poor performance. In a method for obtaining program execution acquisition, a threshold of a hardware performance counter is set to an interrupt trigger value. An interrupt in the execution of a program is caused when the hardware performance counter reaches the threshold. And a monitor program is executed during the interrupt in the execution of the program.

### BACKGROUND OF THE INVENTION

The present invention relates generally to computer systems and, more particularly, to methods for interrupting a program and for obtaining program execution acquisition.

Many computer hardware architectures provide the option of interrupting monitored programs by modifying the program code, e.g., by inserting a trap instruction, and this technique is frequently used in program debugging and monitoring. In some instances, however, the use of code modification to interrupt a program is not available. For example, some programs block code modification by performing control sum checking. In other instances, the program code is so obfuscated that the insertion of a trap instruction is itself a problem.

In view of the foregoing, there is a need for a method of interrupting a program that can be implemented without making changes in the program code.

### SUMMARY OF THE INVENTION

Broadly speaking, the present invention fills this need by providing a method for interrupting a program that uses a hardware performance counter to cause the interruption. A method for obtaining program execution acquisition also is provided.

In accordance with one aspect of the present invention, a method for interrupting a program is provided. In this method, a threshold of a hardware performance counter is adjusted and a program is interrupted when the hardware performance counter reaches the threshold. The method enables a program to be interrupted without changing the program code and thereby avoids any adverse effects on the performance of the program that may be caused by modifying the program code.

In one embodiment, the hardware performance counter is a cycle counter. In one embodiment, the hardware performance counter is an instruction counter. In one embodiment, the threshold of the hardware performance counter is set to an interrupt trigger value, which is a desired amount above a current value of the hardware performance counter. In one embodiment, the threshold of the hardware performance counter is adjusted using a driver that communicates with the operating system.

In one embodiment, the method is used to interrupt the execution of program code on the basis of poor performance. In this embodiment, a performance parameter to be used to monitor performance of program code is selected. The threshold of a hardware performance counter that monitors the selected performance parameter is set to a desired value above a current value of the program counter, with the desired value being indicative of poor performance of the program code. The execution of the program code is interrupted when the current value of the hardware performance counter reaches the threshold. By way of example, the performance parameter used to monitor the performance of the program code may be one of data cache misses, page faults, and mispredictions. In one embodiment, the method further includes passing control to either the operating system and an optimization routine. In one embodiment, the method further includes executing a monitor program while the execution of the program code is interrupted.

In accordance with another aspect of the present invention, a method for obtaining program execution acquisition is provided. In this method, a threshold of a hardware performance counter is set to an interrupt trigger value. An interrupt in the execution of a program is caused when the hardware performance counter reaches the threshold. And a monitor program is executed during the interrupt in the execution of the program. In one embodiment, the interrupt trigger value is a desired amount above a current value of the hardware performance counter.

It is to be understood that the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate exemplary embodiments of the invention and together with the description serve to explain the principles of the invention.

FIG. 1 is a schematic diagram that illustrates the use of a hardware performance counter to interrupt a program in accordance with one embodiment of the invention.

FIG. 2 is a simplified schematic diagram that illustrates how hardware performance counters can be configured to cause an interrupt in accordance with one embodiment of the invention.

FIG. 3 is a flow chart diagram illustrating the method operations performed in interrupting a program in accordance with one embodiment of the present invention.

FIG. 4 is a flow chart diagram illustrating the method operations performed in obtaining program execution acquisition in accordance with one embodiment of the present invention.

### DETAILED DESCRIPTION OF EXEMPLARY EMBODIMENTS

Several exemplary embodiments of the invention will now be described in detail with reference to the accompanying drawings.

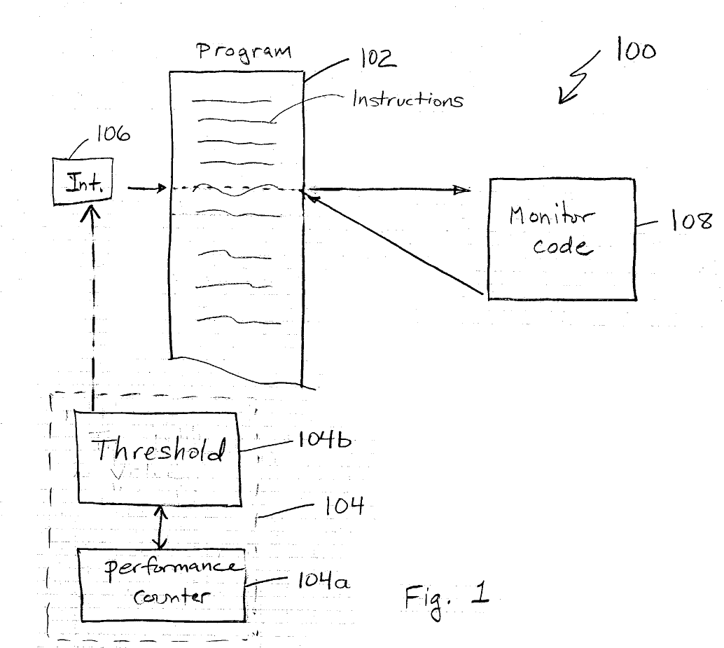

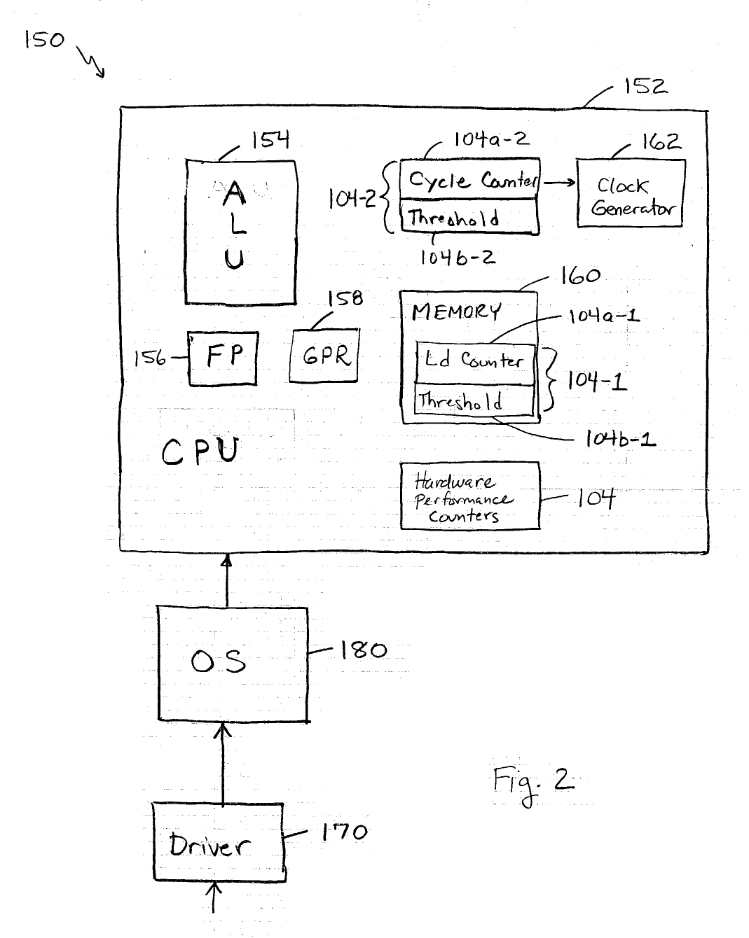

FIG. 1 is a schematic diagram 100 that illustrates the use of a hardware performance counter to interrupt a program in accordance with one embodiment of the invention. As shown in FIG. 1, program 102 includes a series of program instructions, as is well known to those skilled in the art. Hardware performance counter 104 includes two registers: counter 104a and threshold 104b. Additional details regarding hardware performance counters are described below with reference to FIG. 2. The value of counter 104a is continually updated by the operating system. Threshold 104b has a constant value that cannot be changed by the operating system, but can be changed manually, as explained in detail below with reference to FIG. 2.

To interrupt program 102 using hardware performance counter 104, threshold 104b is adjusted to a desired value relative to the current value of counter 104a. When the current value of counter 104a reaches threshold 104b, hardware performance counter 104 gives rise to interrupt 106, which interrupts the execution of program 102 and passes control to monitor code 108. When monitor code 108 has control, the monitor code can execute any desired monitoring functionality relative to program 102, e.g., debugging, collecting performance counters that are indicative of the performance of the program, and the like. Once monitor code 108 has executed the desired monitoring functionality, control may be passed back to program 102.

FIG. 2 is a simplified schematic diagram 150 that illustrates how the hardware performance counters can be configured to cause an interrupt in accordance with one embodiment of the invention. As shown in FIG. 2, central processing unit (CPU) 152 includes arithmetic logic unit (ALU) 154, floating point (FP) 156, general purpose registers (GPR) 158, memory 160, clock generator 162, and hardware performance counters 104. As is known to those skilled in the art, hardware performance counters 104 are special purpose registers that are provided in many known computer hardware architectures to enable hardware performance to be monitored. As shown in FIG. 2, hardware performance counters 104 are indicated generally by the single block designated by reference numeral 104; however, those skilled in the art will understand that the specific hardware performance counters in an actual CPU are spread across the CPU so that each counter can collect different information. Hardware performance counters 104-1 and 104-2 shown in FIG. 2 illustrate locations of exemplary hardware performance counters. Hardware performance counter 104-1, which is used to monitor one aspect of the performance of memory 160, includes load counter 104a-1 and threshold 104b-1. Hardware performance counter 104-2 is coupled to clock generator 162 and includes cycle counter 104a-2 and threshold 104b-2.

To configure hardware performance counters 104 to cause an interrupt, driver 170 is used to obtain access from operating system 180 to the threshold registers, e.g., threshold 104b shown in FIG. 1 and thresholds 104b-1 and 104b-2 shown in FIG. 2, so that one or more threshold registers can be set to a desired value. Driver 170 also causes operating system 180 to cause an interrupt when the value of the specific counter being used, e.g., cycle counter 104a-2, reaches the set value of the threshold, e.g., threshold 104b-2. Upon reviewing this detailed description, those skilled in the art will be able to develop a suitable driver for carrying out the above-described functions.

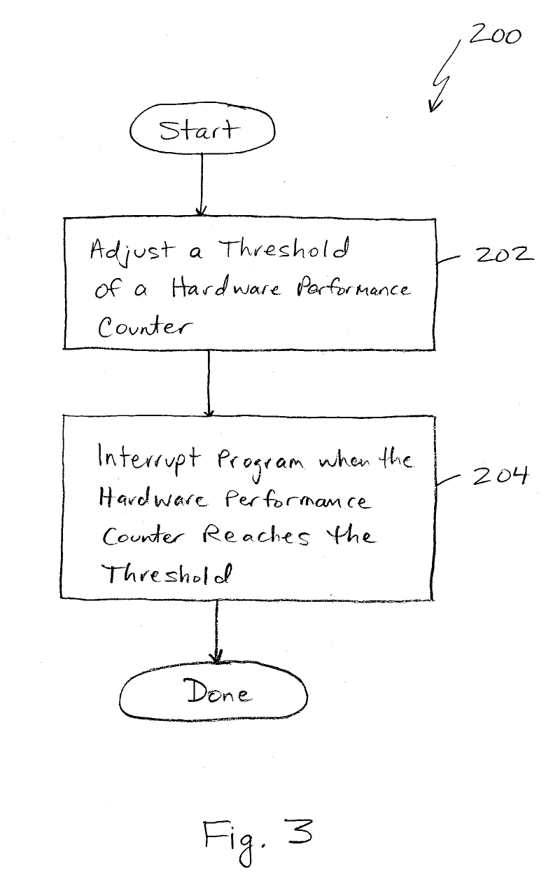

FIG. 3 is a flow chart diagram 200 illustrating the method operations performed in interrupting a program in accordance with one embodiment of the present invention. The method begins in operation 202 in which the threshold of a hardware performance counter is adjusted. In one embodiment, the threshold is adjusted to an interrupt trigger value that is a desired amount above the current value of the counter. By way of example, consider the case in which the hardware performance counter being used is a cycle counter. If the current value of the cycle counter is X and it is desired to cause an interrupt after 1,000 cycles, then the threshold associated with the cycle counter should be adjusted to an interrupt trigger value of X+1,000. In operation 204, the program is interrupted when the hardware performance counter reaches the threshold. In the case of the cycle counter, the operating system will interrupt the program when the current value of the cycle counter reaches X+1,000, i.e., the interrupt trigger value to which the threshold was adjusted.

The method of interrupting a program may be used to monitor the execution of program code and to interrupt the execution of the program code on the basis of poor performance. The performance of the program code may be monitored using any suitable performance parameter. By way of example, the performance parameter may be data cache misses, page faults, or mispredictions. Once the performance parameter to be used to monitor the performance of the program code has been selected, the threshold of the hardware performance counter that monitors the selected performance parameter is set to a desired value that is indicative of poor performance of the program code. By way of example, consider the case in which the performance parameter being used is data cache misses. If it is determined that Y data cache misses is indicative of poor performance during execution of the program code and the current value of the data cache miss counter is X, then the threshold associated with the data cache miss counter should be set to the value of X+Y. When the current value of the data cache miss counter reaches the threshold, i.e., X+Y, the execution of the program code is interrupted and control is passed to either to the operating system or an optimization routine, which can analyze the program code to determine the cause for the poor performance. If desired, a report can be issued advising the user as to the reason why the execution of the program code was interrupted.

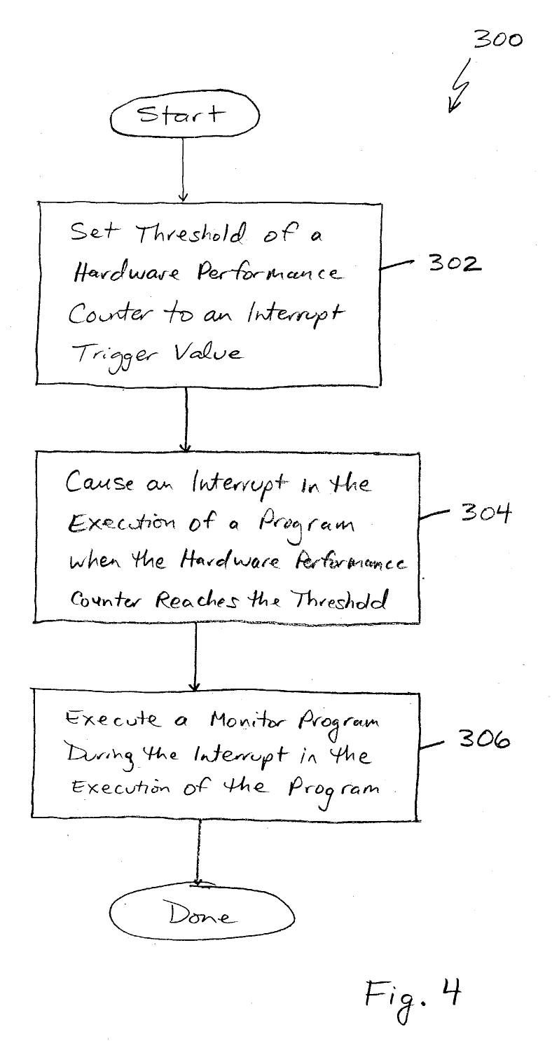

FIG. 4 is a flow chart diagram 300 illustrating the method operations performed in obtaining program execution acquisition in accordance with one embodiment of the present invention. The method begins in operation 302 in which the threshold of a hardware performance counter is set to an interrupt trigger value. In one embodiment, the interrupt trigger value is a desired amount above the current value of the hardware performance counter. In operation 304, an interrupt in the execution of a program is caused when the hardware performance counter reaches the threshold. In operation 306, a monitor program is executed during the interrupt in the execution of the program. The monitor program can carry out any desired monitoring functionality relative to the program, e.g., debugging, collecting performance counters that are indicative of the performance of the program, and the like. Once the monitor program has executed the desired monitoring functionality, control may be passed back to the program so that execution thereof can be resumed.

Those skilled in the art will appreciate that the methods described herein may be implemented using any of the various hardware performance counters provided in computer hardware architectures. Thus, it is to be understood that the specific hardware performance counters mentioned herein are exemplary and the methods described herein are not restricted to use of these specific hardware performance counters. In addition, it will be apparent to those skilled in the art that, if desired, multiple hardware performance counters can be configured to trigger an interrupt in the execution of a program. By way of example, both a cycle counter and an instruction counter can be configured to trigger an interrupt in the execution of a program to monitor whether a certain amount of program instructions are being executed within a given number of clock cycles.

Those skilled in the art will recognize that the order in which the method operations are performed may be varied from that described herein, e.g., by rearranging the order in which the method operations are performed or by performing some of the method operations in parallel. Further, while the present invention has been described in the general context of an application program that is executed on an operating system in conjunction with a test system, it should be appreciated that the invention may be implemented with other routines, programs, components, data structures, etc., which perform particular tasks or implement particular abstract data types. In addition, the present invention may be practiced with other computer system configurations including hand-held devices, microprocessor systems, microprocessor-based or programmable consumer electronics, minicomputers, mainframe computers, and the like.

With the embodiments described herein in mind, it should be understood that the present invention may employ various computer-implemented operations involving data stored in computer systems. These operations are those requiring physical manipulation of physical quantities. These quantities usually, but not necessarily, take the form of electrical or magnetic signals capable of being stored, transferred, combined, compared, and otherwise manipulated. Further, the manipulations performed are often referred to using terms such as producing, identifying, determining, or comparing.

Any of the operations described herein that form part of the present invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The present invention also can be embodied as computer readable code on a computer readable medium. The computer readable medium may be any data storage device that can store data which can be thereafter be read by a computer system. Examples of the computer readable medium include hard drives, network attached storage (NAS), read-only memory, random access memory, CD-ROMs, CD-Rs, CD-RWs, magnetic tapes, and other optical and non-optical data storage devices. The computer readable medium also can be distributed over network coupled computer systems so that the computer readable code is stored and executed in a distributed fashion.

In summary, the present invention provides a method for interrupting a program and a method for obtaining program execution acquisition. The invention has been described herein in terms of several exemplary embodiments. Other embodiments of the invention will be apparent to those skilled in the art from consideration of the specification and practice of the invention. The embodiments and preferred features described above should be considered exemplary, with the invention being defined by the appended claims and equivalents thereof.

What is claimed is:

1. A method for interrupting a program, comprising:
adjusting a threshold of a hardware performance counter; and
interrupting a program when the hardware performance counter reaches the threshold.

2. The method of claim 1, wherein the hardware performance counter is a cycle counter.

3. The method of claim 1, wherein the hardware performance counter is an instruction counter.

4. The method of claim 1, wherein adjusting the threshold of the hardware performance counter includes:
setting the threshold to an interrupt trigger value, the interrupt trigger value being a desired amount above a current value of the hardware performance counter.

5. The method of claim 1, wherein the threshold of the hardware performance counter is adjusted using a driver that communicates with an operating system.

6. A method for obtaining program execution acquisition, comprising:
setting a threshold of a hardware performance counter to an interrupt trigger value;
causing an interrupt in execution of a program when the hardware performance counter reaches the threshold; and
executing a monitor program during the interrupt in the execution of the program.

7. The method of claim 6, wherein the harware performance counter is a cycle counter.

8. The method of claim 6, wherein the hardware performance counter is an instruction counter.

9. The method of claim 6, wherein the interrupt trigger value is a desired amount above a current value of the hardware performance counter.

10. The method of claim 6, wherein the threshold of the hardware performance counter is set using a driver that communicates with an operating system.

11. A method for interrupting execution of program code on the basis of poor performance, comprising:
selecting a performance parameter to be used to monitor performance of program code;
setting a threshold of a hardware performance counter that monitors the selected performance parameter to a desired value above a current value of the program counter, the desired value being indicative of poor performance of the program code; and
interrupting execution of the program code when the current value of the harware performance counter reaches the threshold.

12. The method of claim 11, wherein the performance parameter is selected from the group consisting of data cache misses, page faults, and mispredictions.

13. The method of claim 11, wherein the performance parameter is clock cycles.

14. The method of claim 11, further comprising:
passing control to one of an operating system and an optimization routine.

15. The method of claim 11, further comprising:
executing a monitor program while the execution of the program code is interrupted.

16. The method of claim 11, wherein the threshold of the hardware performance counter is set using a driver that communicates with an operating system.
